(19) United States
(12) Patent Application Publication
(10) Pub. No.: US 2011/0171120 A1
(43) Pub. Date: Jul. 14, 2011

(54) PROCESS FOR PREPARING A DISPERSION COMPRISING TITANIUM-SILICON MIXED OXIDE

(75) Inventors: Wolfgang Lortz, Waechtersbach (DE); Kai Schumacher, Hofheim (DE); Joerg Pietsch, Alzenau (DE)

(73) Assignee: EVONIK DEGUSSA GmbH, Essen (DE)

(21) Appl. No.: 12/677,837

(22) PCT Filed: Sep. 25, 2008
(86) PCT No.: PCT/EP2008/062833

§ 371 Date: Mar. 12, 2010

(30) Foreign Application Priority Data
Oct. 16, 2007 (DE) 102007049742.5

(51) Int. Cl. C01B 39/00

(52) U.S. Cl. 423/700

(57) ABSTRACT

Process for preparing an aqueous dispersion which has a pH of 9 to 14 and comprises particles of a pyrogenic titanium-silicon mixed oxide powder having a proportion of silicon dioxide of 75 to 99.99% by weight and of titanium dioxide of 0.01 to 25% by weight, whose mean aggregate diameter in the dispersion is not more than 200 nm, and at least one basic, quaternary ammonium compound.

The invention relates to a process for preparing a dispersion comprising titanium-silicon mixed oxide powder.

EP-A-814058 discloses the use of titanium-silicon mixed oxide powders for preparing titanium-containing zeolites. Titanium-containing zeolites are efficient catalysts for the oxidation of olefins with hydrogen peroxide. They are obtained by a hydrothermal synthesis proceeding from silicon-titanium mixed oxide powders in the presence of a template. EP-A-814058 discloses that pyrogenic titanium-silicon mixed oxides having a silicon dioxide content of 75 to 99.9% by weight can be used for this purpose. A particularly advantageous composition is one which comprises from 90 to 99.5% by weight of silicon dioxide and 0.5 to 5% by weight of titanium dioxide. The templates used may be amines, ammonium compounds or alkali metal/alkaline earth metal hydroxides.

A disadvantage of the process disclosed in EP-A-814058 is that it leads to products which often do not have reproducible activity and often do not have sufficient catalytic activity.

It was therefore an object of the present invention to provide a process in which the titanium-silicon mixed oxide is present in a form which ensures a high catalytic activity in the further processing to give zeolites.

The invention provides a process for preparing an aqueous dispersion which has a pH of 9 to 14 and comprises
a) particles of a pyrogenic titanium-silicon mixed oxide powder having a proportion of silicon dioxide of 75 to 99.99% by weight and of titanium dioxide of 0.01 to 25% by weight, whose mean aggregate diameter in the dispersion is not more than 200 nm, preferably less than 100 nm,
b) and at least one basic, quaternary ammonium compound, and for which
c) 5≦mol of water/mol of titanium-silicon mixed oxide≦30, preferably 10≦mol of water/mol of titanium-silicon mixed oxide≦20, and
d) 0.005≦mol of ammonium compound/mol of silicon-titanium mixed oxide<0.20,
in which
e) to a liquid phase which is circulated by means of a rotor/stator machine from a reservoir and is composed of water and one or more basic, quaternary ammonium compounds which are present in such an amount that the pH is 10 to 12,
f) via a filling device with the rotor/stator machine running, such an amount of titanium-silicon mixed oxide powder according to claims 1 to 5 is introduced into the shear zone between the slots of the rotor teeth and the stator slots so as to result in a dispersion having a content of titanium-silicon mixed oxide powder of 20 to 40% by weight, in the course of which the pH is kept at 10 to 12 by continuous, further addition of the basic, quaternary ammonium compound, and
g) after all titanium-silicon mixed oxide powder has been added, the filling device is closed, shear is continued such that the shear rate is in the range between 10 000 and 40 000 s⁻¹, and
h) then water and/or further basic, quaternary ammonium compound are optionally added in order to adjust the content of titanium-silicon mixed oxide powder and the pH.

It has been found that, when this dispersion which comprises particles of this fineness is used, the reaction time which is required to prepare titanium-containing zeolites is significantly reduced. The mean aggregate diameter is preferably less than 100 nm.

“Pyrogenic” is understood to mean mixed metal oxide particles obtained by flame oxidation and/or flame hydrolysis. Oxidizable and/or hydrolysable starting materials are generally oxidized or hydrolysed in a hydrogen-oxygen flame. The inventive mixed metal oxide particles are very substantially pore-free and have free hydroxyl groups on the surface. They are present in the form of aggregated primary particles.

The BET surface area of the pyrogenic titanium-silicon mixed oxide powder used is not limited. However, it has been found to be advantageous when the BET surface area is within a range of 20 to 400 m²/g and especially of 50 to 300 m²/g. The use of a titanium-silicon mixed oxide powder with a high BET surface area in combination with a small mean aggregate diameter in the dispersion is particularly advantageous for the preparation of titanium-containing zeolites.

It has also been found to be advantageous when the pyrogenic titanium-silicon mixed oxide powder used contains less than 50 ppm, preferably less than 25 ppm, of the elements Na, K, Fe, Co, Ni, Al, Ca and Zn.

The basic, quaternary ammonium compound used may, for example, be tetraethylammonium hydroxide, tetra-n-propyl-ammonium hydroxide and/or tetra-n-butylammonium hydroxide. Basic, quaternary ammonium compounds serve as the templates which determine the crystal structure by incorporation into the crystal lattice. Tetra-n-propylammonium hydroxide is preferably used for the preparation of titanium silicalite-1 (MFI structure), tetra-n-butylammonium hydroxide for the preparation of titanium silicalite-2 (MEL structure) and tetraethylammonium hydroxide for the preparation of titanium β-zeolites (BEA crystal structure).

The proportion of quaternary, basic ammonium compound in the inventive dispersion is not limited. If the dispersion is to be stored for a prolonged period, it may be advantageous to add to the dispersion only a portion of the amount needed to prepare a titanium-containing zeolite. The quaternary, basic ammonium compound can preferably be added in such an amount as to result in a pH of 9 to 11. In this pH range, the dispersion exhibits good stability.

If the dispersion is, for example, to be used immediately after its preparation to prepare a titanium-containing zeolite, the dispersion may already also comprise the entire amount of quaternary, basic ammonium compound. In that case, preferably, 0.08≦mol of ammonium compound/mol of silicon-titanium mixed oxide<0.17.

The dispersion prepared by the process according to the invention can be used to prepare a titanium-containing zeolite. In this case, the dispersion, optionally with further addition of the basic, quaternary ammonium compound, is treated at a temperature of 150 to 220° C. over a period of less than 12 hours. The resulting crystals are separated out by filtration, centrifugation or decantation and washed with a suitable wash liquid, preferably water.

The crystals can then be dried if required and calcined at a temperature between 400° C. and 1000° C., preferably between 500° C. and 750° C., in order to remove the template.

The titanium-containing zeolite is obtained in powder form. For its use as an oxidation catalyst, it is, if required, converted by known methods for shaping pulverulent catalysts, for example pelletizing, spray-drying, spray-pelletizing or extrusion, to a form suitable for use, for example to micropellets, spheres, tablets, solid cylinders, hollow cylinders or honeycomb.

The titanium-containing zeolite can be used as a catalyst in oxidation reactions with hydrogen peroxide. More particularly, it can be used as a catalyst in the epoxidation of olefins with the aid of aqueous hydrogen peroxide in a water-miscible solvent.

### EXAMPLES

### Feedstocks

Titanium-silicon mixed oxide powder 1 (Ti—Si-MOX): 6.0 kg/h of silicon tetrachloride and 0.26 kg/h of titanium tetrachloride are evaporated. The vapours are transferred to a mixing chamber by means of 15 m³ (STP)/h of nitrogen as carrier gas. Separately therefrom, 3.3 m³ (STP)/h of hydrogen and 11.6 m³ (STP)/h of primary air are introduced into the mixing chamber. In a central tube, the reaction mixture is supplied to a burner and ignited. The flame burns into a water-cooled flame tube. In addition, 13 m³ (STP)/h of secondary air and 0.5 m³ (STP)/h of peripheral hydrogen are introduced into the reaction chamber. The powder formed is separated out in a downstream filter and then treated in countercurrent with steam at 520° C.

Ti—Si-MOX 1 has a BET surface area of 305 m²/g, a DBP number of 275 g/100 g, a proportion of SiO₂ of 95% by weight and a proportion of TiO₂ of 5% by weight. The proportion of Na is <10 ppm, that of K<10 ppm, that of Fe≦1 ppm, that of Co<1 ppm, that of Ni<1 ppm, that of Al<10 ppm, that of Ca<10 ppm and that of Zn<10 ppm. Ti—Si-MOX 1 has a pH in a 4% dispersion in water of approx. 3.6.

Titanium-silicon mixed oxide powder 2 (Ti—Si-MOX 2) corresponds to Example 18 in EP-A-1553054. Ti—Si-MOX 2 has a BET surface area of 43 m²/g, a proportion of SiO₂ of 83% by weight and a proportion of TiO₂ of 17% by weight.

### Example 1

### Preparation of a Dispersion

### Inventive

A 100 l stainless steel mixing vessel is initially charged with 32.5 g of demineralized water. Subsequently, a pH of approx. 11 is established with tetra-n-propylammonium hydroxide solution (TPAOH) (40% by weight in water). Then, with the aid of the suction nose of the Ystral Conti-TDS 4 (stator slots: 6 mm ring and 1 mm ring, rotor/stator distance approx. 1 mm), under shear conditions, 17.5 kg of Ti—Si-MOX 1 are sucked in. During the suction of the powder, the pH is kept between 10 and 11 by further addition of the TPAOH. After the suction has ended, the suction nozzle is closed, the pH is adjusted to 11 with TPAOH and the 33% strength by weight predispersion is sheared at 3000 rpm for another 10 min. Undesired heating of the dispersion as the result of the high energy input is countered by a heat exchanger and the temperature rise is limited to max. 40° C.

In order to ensure a very high storage stability, the product is diluted with 25.8 kg of demineralized water, mixed thoroughly and adjusted once again to a pH of 11.0 with a little TPAOH.

Concentration of silicon-titanium mixed oxide: 22% by weight. A total of 3.8 kg of tetra-n-propylammonium hydroxide solution (40% by weight in water) are used.

The dispersion has the following values: water/silicon-titanium mixed oxide 11.5, mean aggregate diameter 92 nm (determined with Horiba LA 910).

### Example 2

### Preparation of a Dispersion

### Comparative

A 100 l stainless steel mixing vessel is initially charged with 32.5 kg of demineralized water. Subsequently, with the aid of the suction nose of the Ystral Conti-TDS 4 (stator slots: 6 mm ring and 1 mm ring, rotor/stator distance approx. 1 mm), under shear conditions, 13.6 kg of Ti—Si-MOX 1 are sucked in.

This forms a dispersion with a content of silicon-titanium mixed oxide of 28% by weight, which has a high viscosity and a low stability.

### Example 3

### Preparation of a Dispersion

### Comparative

A 100 l stainless steel mixing vessel is initially charged with 32.5 kg of demineralized water. Subsequently, tetra-n-propylammonium hydroxide solution (TPAOH) (40% by weight in water) is used to establish a pH of approx. 13.5. Then, with the aid of the suction nose of the Ystral Conti-TDS 4 (stator slots: 6 mm ring and 1 mm ring, rotor/stator distance approx. 1 mm) under shear conditions, 17.5 kg of Ti—Si-MOX 1 are sucked in. This results in vigorous foaming of the dispersion. Further dispersion is not possible.

### Example 4

### Preparation of a Dispersion

### According to Invention

Procedure analogous to Example 1, except using Ti—Si-MOX 2 instead of Ti—Si-MOX 1.

The dispersion has the following values: water/silicon-titanium mixed oxide 11.5, mean aggregate diameter 131 nm (determined with Horiba LA 910).

The examples show that, even though the titanium-silicon-mixed oxide powder used consists predominantly of silicon dioxide, a dispersion technique in the acidic pH range which is known for silicon dioxide is not suitable for preparing extremely fine (<200 nm) and highly filled dispersions. Instead, the dispersion according to the invention in the alkaline range leads to a dispersion with the desired particle fineness and solids content.

A dispersion of pure silicon dioxide with comparable BET surface area, for example CAB-O-SIL® H-5, from Cabot, BET surface area=300 m²/g) would not lead to the desired particle fineness and solids content under these conditions.

The examples also show that a portion of the basic, quaternary ammonium compound has to be added together with the titanium silicon mixed oxide powder, i.e. the complete addition of the base before introduction of the powder does not lead to the goal.

1. Process for preparing an aqueous dispersion which has a pH of 9 to 14 and comprises
a) particles of a pyrogenic titanium-silicon mixed oxide powder having a proportion of silicon dioxide of 75 to 99.99% by weight and of titanium dioxide of 0.01 to 25% by weight, whose mean aggregate diameter in the dispersion is not more than 200 nm,
b) and at least one basic, quaternary ammonium compound, and for which
c) 5≦mol of water/mol of titanium-silicon mixed oxide≦30 and
d) 0.005≦mol of ammonium compound/mol of silicon-titanium mixed oxide<0.20,
in which
e) to a liquid phase which is circulated by means of a rotor/stator machine from a reservoir and is composed of water and one or more basic, quaternary ammonium compounds which are present in such an amount that the pH is 10 to 12,
f) via a filling device with the rotor/stator machine running, such an amount of titanium-silicon mixed oxide powder according to claims 1 to 5 is introduced into the shear zone between the slots of the rotor teeth and the stator slots so as to result in a dispersion having a content of titanium-silicon mixed oxide powder of 20 to 40% by weight, in the course of which the pH is kept at 10 to 12 by continuous, further addition of the basic, quaternary ammonium compound, and
g) after all titanium-silicon mixed oxide powder has been added, the filling device is closed, shear is continued such that the shear rate is in the range between 10 000 and 40 000 s⁻¹, and
h) then water and/or further basic, quaternary ammonium compound are optionally added in order to adjust the content of titanium-silicon mixed oxide powder and the pH.
